(19) United States
(12) Patent Application Publication
(10) Pub. No.: US 2012/0009394 A1
(43) Pub. Date: Jan. 12, 2012

(54) BONDING METHOD AND BONDING SUBSTRATE

(75) Inventor: Jui-Hung CHENG, Hsinchu County (TW)

(73) Assignee: MOS Art Pack Corporation, Hsinchu (TW)

(21) Appl. No.: 12/831,404

(22) Filed: Jul. 7, 2010

(51) Int. Cl. B32B 3/10; B32B 3/02; B05D 5/06; B32B 37/02; B44C 1/22

(52) U.S. Cl. 428/194; 156/99; 216/24; 427/162; 427/532; 428/195.1

(57) ABSTRACT

A bonding method and a bonding substrate are provided. The bonding substrate is applied to a silicon wafer having the same shape. The bonding method includes the following steps. Firstly, the optical glass substrate is processed to form a first alignment mark. Then, an adhesive layer is coated on a surface of the optical glass substrate. The adhesive layer on the surface of the optical glass substrate is partially removed, thereby defining an adhesive structure. According to the first alignment mark of the optical glass substrate and a second first alignment mark of the silicon wafer, alignment between the optical glass substrate and the silicon wafer is performed. Afterwards, the optical glass substrate and the silicon wafer are bonded together through the adhesive structure.

### FIELD OF THE INVENTION

The present invention relates to a bonding method and a bonding substrate, and more particularly to a bonding method for use between a silicon wafer and an optical glass substrate and a bonding substrate applied to a silicon wafer.

### BACKGROUND OF THE INVENTION

In the process of fabricating an integrated circuit (IC) chip, it is essential to bond a glass substrate and a silicon wafer together. For example, in a CMOS image sensor fabricating process, a CMOS image sensor wafer is firstly bonded to an optical glass substrate, and then cut apart to produce several CMOS image sensors containing optical glass passivation layers.

FIGS. 1A, 1B and 1C are schematic views illustrating a process of attaching a CMOS image sensor wafer on an optical glass substrate having the same shape according to the prior art. As shown in FIG. 1A, an adhesive layer 12 is formed on an optical glass substrate 11 by spin-coating an adhesive. Due to the cohesion of the adhesive, a thicker hump 120 is formed at the edge of the optical glass substrate 11. Hence, after a silicon wafer 10 is attached on the optical glass substrate 11, the hump 120 may overflow through the edge of the optical glass substrate 11 (see FIG. 1B). Moreover, since the silicon wafer 10 and the optical glass substrate 11 have no alignment marks, an alignment error is readily generated during the process of boning the silicon wafer 10 on the optical glass substrate 11 (see FIG. 1C). As known, the alignment error may adversely affect the subsequent fabricating process.

Therefore, there is a need of providing improved bonding method and substrate in order to obviate the drawbacks encountered from the prior art.

### SUMMARY OF THE INVENTION

An object of the present invention provides a bonding method for use between a silicon wafer and an optical glass substrate having the same shape in order to avoid the misalignment problem encountered from the prior art.

Another object of the present invention provides a bonding substrate applied to a silicon wafer having the same shape in order to avoid the misalignment problem resulted from the use of the conventional bonding substrate.

In accordance with an aspect of the present invention, there is provided a bonding method for use between a silicon wafer and an optical glass substrate having the same shape. The bonding method includes the following steps. Firstly, the optical glass substrate is processed to form a first alignment mark. Then, an adhesive layer is coated on a surface of the optical glass substrate. The adhesive layer on the surface of the optical glass substrate is partially removed, thereby defining an adhesive structure. According to the first alignment mark of the optical glass substrate and a second first alignment mark of the silicon wafer, alignment between the optical glass substrate and the silicon wafer is performed. Afterwards, the optical glass substrate and the silicon wafer are bonded together through the adhesive structure.

In accordance with another aspect of the present invention, there is provided a bonding substrate applied to a silicon wafer having the same shape. The bonding substrate includes an optical glass substrate, an adhesive structure and a first alignment mark. The adhesive structure overlies the optical glass substrate for providing adhesion required to bond the silicon wafer on the optical glass substrate. The first alignment mark is formed on the optical glass substrate. After alignment between the optical glass substrate and the silicon wafer is performed according to the first alignment mark of the optical glass substrate and a second first alignment mark of the silicon wafer, the optical glass substrate and the silicon wafer are bonded together through the adhesive structure.

In an embodiment, the adhesive layer is formed by spin-coating an adhesive photoresist material on the surface of the optical glass substrate, and the adhesive structure is defined by using a mask to pattern the photoresist material. The photomask further includes a third alignment mark corresponding to the first alignment mark for facilitating alignment during the adhesive structure is formed by exposure with the photomask.

In an embodiment, the first alignment mark is formed by performing a sandblasting treatment on the optical glass substrate, and an edge ring structure is simultaneously formed at an edge of the optical glass substrate by the sandblasting treatment.

In an embodiment, the location of the adhesive structure corresponds to a scribe line of the silicon wafer.

### BRIEF DESCRIPTION OF THE DRAWINGS

The above contents of the present invention will become more readily apparent to those ordinarily skilled in the art after reviewing the following detailed description and accompanying drawings, in which:

FIGS. 1A, 1B and 1C are schematic views illustrating a process of attaching a CMOS image sensor wafer on an optical glass substrate having the same shape according to the prior art;

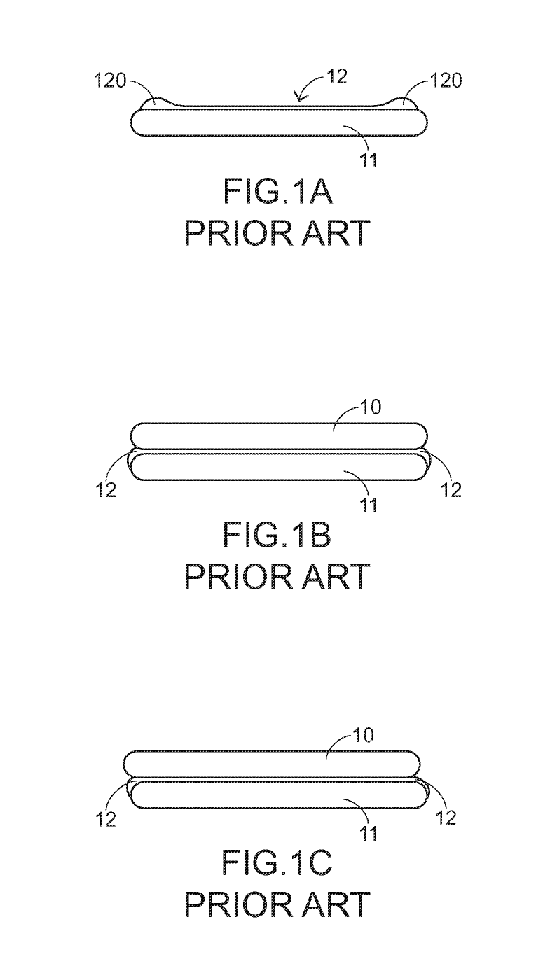

FIGS. 2A, 2B, 2C and 2D are schematic views illustrating a process of attaching a CMOS image sensor wafer on an optical glass substrate having the same shape according to an embodiment of the present invention;

FIGS. 3A, 3B and 3C are schematic top views illustrating the optical glass substrate, the CMOS image sensor wafer and the photomask, respectively; and

FIGS. 4A and 4B are schematic views illustrating the shapes of two exemplary first alignment marks according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

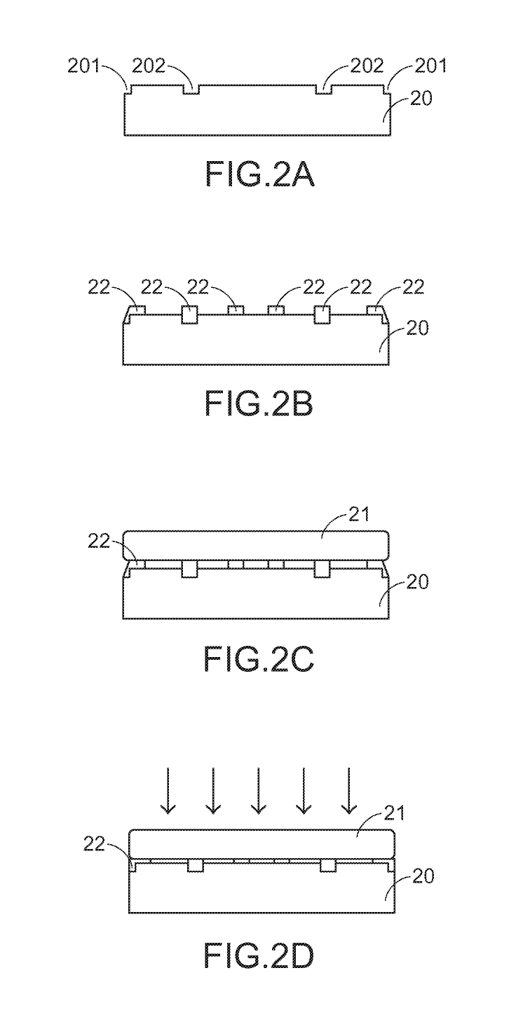

FIGS. 2A, 2B, 2C and 2D are schematic views illustrating a process of attaching a CMOS image sensor wafer on an optical glass substrate having the same shape according to an embodiment of the present invention.

As shown in FIG. 2A, an edge and a surface of an optical glass substrate 20 is subject to a processing treatment (e.g. a sandblasting treatment) to form an edge ring structure 201 and a first alignment mark 202, respectively. Then, an adhesive layer is formed on the optical glass substrate 20 by spin-coating an adhesive photoresist material (e.g. a photosensitive silica gel manufactured by Shin-Etsu Chemical Co., Ltd., Japan).

Then, by using a photomask (not shown) to pattern the photoresist material on the optical glass substrate 20, an adhesive structure 22 as shown in FIG. 2B is defined. The location of the adhesive structure 22 corresponds to the scribe line of the CMOS image sensor wafer. In principle, the CMOS image sensor on the silicon wafer is not covered by the adhesive structure 22. Moreover, the location of the first alignment mark 202 also corresponds to the scribe line of the CMOS image sensor wafer, so that the adhesive structure 22 is also remaindered on the first alignment mark 202. Due to the edge ring structure 201, the adhesive structure 22 at the edge of the optical glass substrate 20 is no longer too thick. Moreover, the photomask (not shown) also has a third alignment mark corresponding to the first alignment mark 202. As such, during the adhesive structure 22 as shown in FIG. 2B is formed by photomask exposure, the location precision could be effectively controlled.

Next, as shown in FIG. 2C, the optical glass substrate 20 having the adhesive structure 22 is aligned with the CMOS image sensor wafer 21 by means of the first alignment mark 202. Since the CMOS image sensor wafer 21 has a second alignment mark (not shown) aligned with the first alignment mark 202, the misalignment problem encountered from the prior art will be effectively obviated.

Afterwards, as shown in FIG. 2D, after the alignment between the optical glass substrate 20 and the CMOS image sensor wafer 21, an external force is exerted on the CMOS image sensor wafer 21 to bond the CMOS image sensor wafer 21 on the optical glass substrate 20. Due to the edge ring structure 201, the adhesive structure 22 at the edge of the optical glass substrate 20 and the adhesive structure 22 in the middle of the optical glass substrate 20 are substantially uniform in thickness. As a consequence, after the CMOS image sensor wafer 21 is bonded on the optical glass substrate 20, the overflow problem encountered from the prior art will be eliminated.

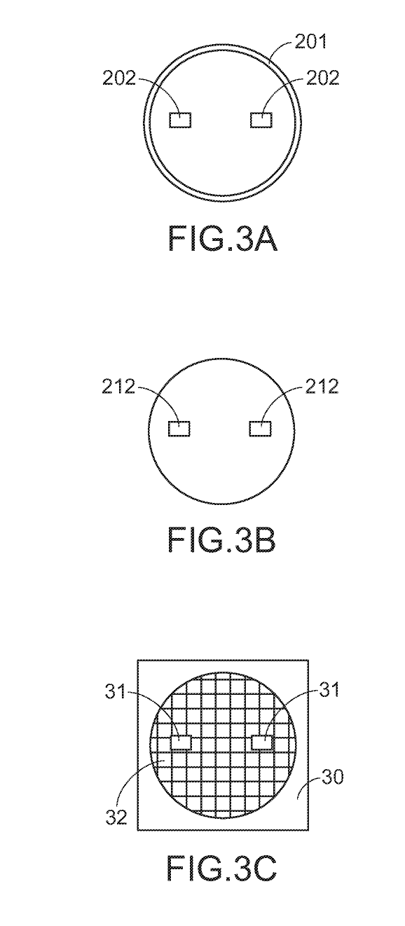

FIGS. 3A, 3B and 3C are schematic top views illustrating the optical glass substrate 20, the CMOS image sensor wafer 21 and the photomask 30, respectively. In FIG. 3A, the locations of the edge ring structure 201 and the first alignment mark 202 of the optical glass substrate 20 are clearly shown. It is preferred that the optical glass substrate 20 has two first alignment marks 202. It is noted that one, three or more than three first alignment marks 202 are also feasible. In FIG. 3B, the locations of the second alignment marks 212 of the CMOS image sensor wafer 21 are shown. The locations and number of the second alignment marks 212 are dependent on the locations and number of the first alignment marks 202 of the optical glass substrate 20. More especially, the second alignment marks 212 may be simultaneously produced with the CMOS image sensors. By using an automatic alignment device with an image recognition function, the alignment between the optical glass substrate 20 and the silicon wafer 21 could be precisely performed according to the first alignment marks 202 and the corresponding second alignment marks 212. FIG. 3C is a schematic top view illustrating the photomask. The photomask 31 has third alignment marks 31 corresponding to the locations of the first alignment marks 202. In addition, the photomask 31 has a photomask pattern 32 for patterning the photoresist material and forming the adhesive structure 22.

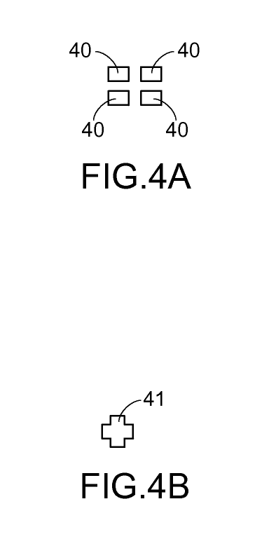

FIGS. 4A and 4B are schematic views illustrating the shapes of two exemplary first alignment marks 202. As shown in FIG. 4A, the first alignment mark is defined by four rectangular indentations 40 in the substrate. Whereas, as shown in FIG. 4A, the first alignment mark is defined by a cross-shaped indentation 41.

From the above description, the bonding method of the present invention is capable of eliminating the overflow problem and the alignment error, which are encountered from the prior art.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A bonding method for use between a silicon wafer and an optical glass substrate having the same shape, the bonding method comprising steps of:
processing the optical glass substrate to form a first alignment mark;
coating an adhesive layer on a surface of the optical glass substrate;
partially removing the adhesive layer on the surface of the optical glass substrate, thereby defining an adhesive structure;
performing alignment between the optical glass substrate and the silicon wafer according to the first alignment mark of the optical glass substrate and a second first alignment mark of the silicon wafer; and
bonding the optical glass substrate and the silicon wafer through the adhesive structure.

2. The bonding method according to claim 1 wherein the first alignment mark is formed by performing a sandblasting treatment on the optical glass substrate, and an edge ring structure is simultaneously formed at an edge of the optical glass substrate by the sandblasting treatment.

3. The bonding method according to claim 1 wherein the adhesive layer is formed by spin-coating an adhesive photoresist material on the surface of the optical glass substrate, and the adhesive structure is defined by using a mask to pattern the photoresist material.

4. The bonding method according to claim 3 wherein the photomask further comprises a third alignment mark corresponding to the first alignment mark for facilitating alignment during the adhesive structure is formed by exposure with the photomask.

5. The bonding method according to claim 1 wherein the location of the adhesive structure corresponds to a scribe line of the silicon wafer.

6. A bonding substrate applied to a silicon wafer having the same shape, the bonding substrate comprising:
an optical glass substrate;
an adhesive structure overlying the optical glass substrate for providing adhesion required to bond the silicon wafer on the optical glass substrate; and
a first alignment mark formed on the optical glass substrate, wherein after alignment between the optical glass substrate and the silicon wafer is performed according to the first alignment mark of the optical glass substrate and a second first alignment mark of the silicon wafer, the optical glass substrate and the silicon wafer are bonded together through the adhesive structure.

7. The bonding substrate according to claim 6 wherein the first alignment mark is an indentation formed by performing a sandblasting treatment on the optical glass substrate, and an edge ring structure is simultaneously formed at an edge of the optical glass substrate by the sandblasting treatment.

8. The bonding substrate according to claim 6 wherein the adhesive layer is formed by spin-coating an adhesive photoresist material on a surface of the optical glass substrate, and the adhesive structure is defined by using a mask to pattern the photoresist material.

9. The bonding substrate according to claim 8 wherein the photomask further comprises a third alignment mark corresponding to the first alignment mark for facilitating alignment during the adhesive structure is formed by exposure with the photomask.

10. The bonding substrate according to claim 6 wherein the location of the adhesive structure corresponds to a scribe line of the silicon wafer.
